(19) United States
(12) Patent Application Publication
(10) Pub. No.: US 2015/0194830 A1
(43) Pub. Date: Jul. 9, 2015

(54) POWER SUPPLY CHARGING METHODS AND DEVICES

(71) Applicant: Xiaomi Inc., Beijing (CN)

(72) Inventors: Zhenfei Lei, Beijing (CN); Wei Sun, Beijing (CN); Diling Guo, Beijing (CN)

(73) Assignee: Xiaomi Inc.

(21) Appl. No.: 14/513,615

(22) Filed: Oct. 14, 2014

Related U.S. Application Data
(63) Continuation of application No. PCT/CN2014/082951, filed on Jul. 24, 2014.

(30) Foreign Application Priority Data
Jan. 9, 2014 (CN) 201410010338.5

(51) Int. Cl. H02J 7/00

(52) U.S. Cl. CPC H02J 7/0029; H02J 7/0077; H02J 2007/0037

(57) ABSTRACT

A power supply charging method is provided. The method includes: detecting a positive electrode voltage of a cell in a power supply when the power supply is in a charging state; determining that the detected positive electrode voltage of the cell is not lower than a preset voltage; and controlling a charging mode of the power supply to be switched from a constant current charging mode into a constant voltage charging mode.

### CROSS-REFERENCE TO RELATED APPLICATIONS

This application is a continuation of International Application PCT/CN2014/082951, filed Jul. 24, 2014, which claims priority to Chinese Patent Application No. 201410010338.5, filed Jan. 9, 2014, the entire contents of all of which are incorporated herein by reference.

### TECHNICAL FIELD

The present disclosure generally relates to the field of power supply technology and, more particularly, to power supply charging methods and devices.

### BACKGROUND

A rechargeable power supply of a terminal device generally includes a cell and a protection circuit, where the cell is an electricity storage portion of the rechargeable power supply, and the protection circuit is used to protect charging and discharging processes of the cell.

A single-cell rechargeable power supply (i.e., a power supply that includes one cell) generally adopts a constant-current constant-voltage mode. That is, the single-cell rechargeable power supply is charged in a mode of using a large constant current at first, and when a voltage of the power supply reaches a threshold value, it begins to be charged in a mode of using a constant voltage mode in which a charging current is gradually decreased. The constant-current constant-voltage charging mode may sufficiently lengthen the time duration of a constant current charging process, thereby greatly reducing the time duration of a constant voltage charging process, and shortening a total charging time on the whole.

Conventionally, a power supply charging control circuit detects a positive electrode voltage of the power supply, and the presence of a protection element and the protection circuit may cause that the positive electrode voltage of the power supply is higher than a positive electrode voltage of the cell in the power supply. It is, therefore, not accurate to switch the charging mode based only on whether the voltage of the power supply reaches the threshold value, which may lead to an inaccurate timing of controlling the constant current charging mode to be switched into the constant voltage charging mode. As a result, a time duration of constant current charging may be reduced, thereby lengthening the total charging time of the power supply and decreasing the charging speed.

### SUMMARY

According to a first aspect of the present disclosure, there is provided a power supply charging method, comprising: detecting a positive electrode voltage of a cell in a power supply when the power supply is in a charging state; determining that the detected positive electrode voltage of the cell is not lower than a preset voltage; and controlling a charging mode of the power supply to be switched from a constant current charging mode into a constant voltage charging mode.

According to a second aspect of the present disclosure, there is provided a power supply charging circuit, comprising a power supply and a power supply management chip, wherein the power supply comprises a cell, the power supply management chip is electrically connected to a positive electrode and a negative electrode of the cell in the power supply to detect a positive electrode voltage of the cell, and the power supply management chip controls a charging mode of the power supply based on the detected positive electrode voltage of the cell.

According to a third aspect of the present disclosure, there is provided a power supply, comprising: a positive pin; a negative pin; a set pin; a cell; a first protection element; and a second protection element, wherein a positive electrode of the cell is connected to the positive pin of the power supply via the second protection element, and is connected to a power supply management chip via the set pin of the power supply, and a negative electrode of the cell is connected to the negative pin of the power supply via the first protection element.

It is to be understood that both the foregoing general description and the following detailed description are exemplary rather than limiting the present disclosure.

### BRIEF DESCRIPTION OF THE DRAWINGS

The accompanying drawings, which are incorporated in and constitute a part of this specification, illustrate the embodiments according to the present disclosure, and serve to explain the principles of the present disclosure.

FIG. 1a is a flowchart showing a power supply charging method, according to an exemplary embodiment.

FIG. 1b is a diagram showing a charging time of a power supply charging method, according to an exemplary embodiment.

FIG. 2 is a flowchart showing another power supply charging method, according to an exemplary embodiment.

FIG. 3 is a block diagram showing a power supply charging circuit, according to an exemplary embodiment.

FIG. 4 is a block diagram showing another power supply charging circuit, according to an exemplary embodiment.

FIG. 5 is a block diagram showing still another power supply charging circuit, according to an exemplary embodiment.

FIG. 6 is a block diagram showing yet still another power supply charging circuit, according to an exemplary embodiment.

FIG. 7 is a block diagram showing yet still another power supply charging circuit, according to an exemplary embodiment.

FIG. 8 is a block diagram showing a power supply, according to an exemplary embodiment.

FIG. 9 is a block diagram showing another power supply, according to an exemplary embodiment.

FIG. 10 is a block diagram showing still another power supply, according to an exemplary embodiment.

FIG. 11 is a block diagram showing yet still another power supply charging circuit, according to an exemplary embodiment.

FIG. 12 is a block diagram showing yet still another power supply charging circuit, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The following exemplary embodiments and description thereof intend to illustrate, rather than to limit, the present disclosure. Hereinafter, the present disclosure will be described with reference to the drawings.

A power supply generally includes a cell and a protection circuit, where the protection circuit is used to protect charging and discharging processes of the cell. When a charging current or a discharging current of the cell is too large or a voltage of the cell is too low, the cell is protected by limiting the current or cutting off the circuit in which the cell is positioned. Since the protection circuit has a certain voltage drop, the voltage of the power supply is not equal to the voltage of the cell inside the power supply. When the power supply is in a charging state, and the voltage of the power supply reaches a preset voltage, the voltage of the cell may not reach the preset voltage.

Embodiments of the present disclosure provide a power supply charging method which detects a voltage across positive and negative electrodes of a cell in a power supply, and controls a charging mode of the power supply to be switched from a constant current charging mode into a constant voltage charging mode when it is determined that the positive electrode voltage of the cell is not lower than a preset voltage. In doing so, a constant current charging time of the power supply is lengthened, a total charging time of the power supply is reduced, and a charging speed of the power supply is increased.

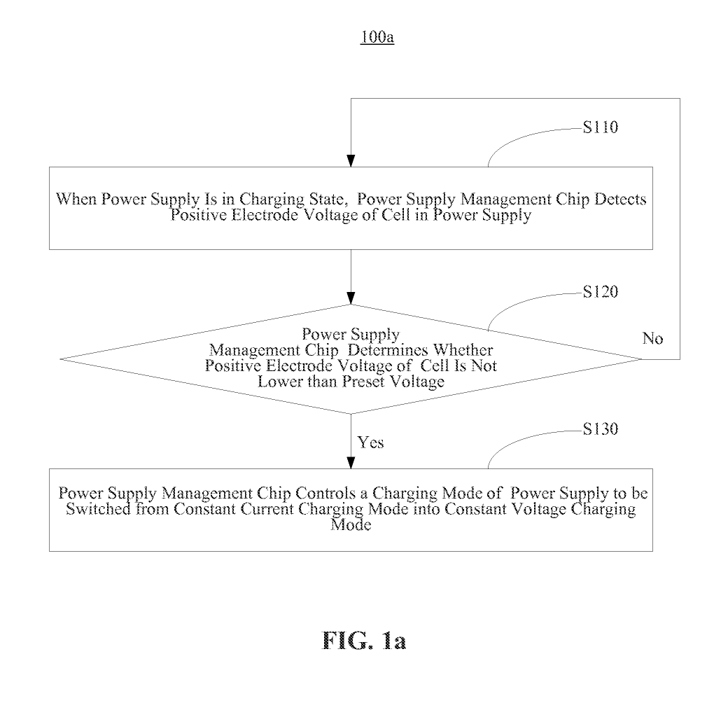

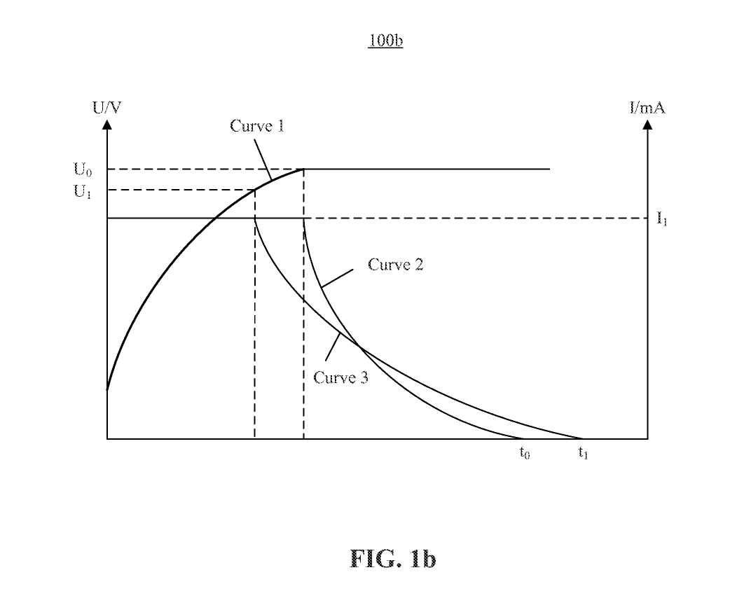

FIG. 1a is a flowchart of a power supply charging method 100a, according to an exemplary embodiment. For example, the method 100a may be applied in a power supply charging circuit. Referring to FIG. 1a, the method 100a includes the following steps.

In step S110, when a power supply is in a charging state, a power supply management chip detects a positive electrode voltage of a cell in the power supply.

It is to be understood that, the power supply in the embodiments of the present disclosure may be a battery in a mobile terminal device (such as a mobile phone, a PDA or the like), or may be electricity storage means in other devices, which are not limited by the present disclosure.

In one exemplary embodiment, the power supply management chip is electrically connected to a positive electrode and a negative electrode of the cell. When the power supply is in the charging state, the power supply management chip detects a voltage across the positive electrode and the negative electrode of the cell. In some embodiments, the negative electrode of the cell is electrically connected to a ground end, so a corresponding pin of the power supply management chip is also electrically connected to the ground end. Accordingly, another corresponding pin of the power supply management chip is electrically connected to the positive electrode of the cell, so as to detect the positive electrode voltage of the cell. For example, the power supply management chip may be electrically connected to a set pin of the power supply, to detect the positive electrode voltage of the cell, and the set pin may be electrically connected to the positive electrode of the cell.

In one exemplary embodiment, the set pin of the power supply may be a newly added pin in the power supply. The newly added pin is electrically connected to the positive electrode of the cell in the power supply, which may be electrically connected directly. The power supply management chip may detect a voltage of the newly added pin of the power supply to obtain the positive electrode voltage of the cell.

In some embodiments, the set pin of the power supply may be an id pin of the power supply, and the power supply management chip may acquire a power supply identification (id) number that represents the identity of the power supply via the id pin of the power supply.

In step S120, the power supply management chip determines whether the detected positive electrode voltage of the cell is not lower than a preset voltage. If it is determined that the positive electrode voltage of the cell is not lower than the preset voltage, step S130 is performed. If the positive electrode voltage of the cell is lower than the preset voltage, the method 100a returns to step S110. The preset voltage may be determined according to a voltage when the power supply is fully charged, for example, the preset voltage may be 4.35 V.

In step S130, if the positive electrode voltage of the cell lower than the preset voltage, the power supply management chip controls a charging mode of the power supply to be switched from a constant current charging mode into a constant voltage charging mode.

FIG. 1b is a diagram 100b showing a charging voltage and a charging current versus a charging time, according to an exemplary embodiment. In FIG. 1b, the horizontal axis corresponds to time, the vertical axis on the left corresponds to voltage, and the vertical axis on the right corresponds to current. Curve 1 in FIG. 1b shows a charging voltage changing curve in a constant-current constant-voltage charging mode. Curve 2 shows a charging current changing curve corresponding to the power supply charging method provided by an embodiment disclosed in the present disclosure, such as the method 100a provided above. Curve 3 shows a charging current changing curve in a conventional constant-current constant-voltage charging mode. A voltage of the positive electrode of the power supply is higher than a voltage of the positive electrode of the cell inside in the power supply. In one example, a preset voltage U₀ is set to be 4.35V. When it is detected that the voltage of the positive electrode of the power supply reaches 4.35V, after a voltage drop is removed, a voltage U₁ between the electrodes of the cell in the power supply may be at a lower value, for example, at 4.05V. As indicated by Curve 3, in the conventional constant-current constant-voltage charging mode, before the voltage between the electrodes of the cell reaches the preset voltage U₀, the charging mode of the power supply is switched from the constant current mode into the constant voltage mode, and the charging is completed at a time t₁. As indicated by Curve 2, in a method provided by an embodiment disclosed in the present disclosure, such as the method 110a, when the power supply management chip detects that a positive electrode voltage U₀ of the cell reaches the preset voltage, for example, 4.35V, the charging mode of the power supply is switched from the constant current mode into the constant voltage mode, and the charging is completed at a time t₀, smaller than t₁. Since the power supply charging method of the present disclosure lengthens the time duration of constant current charging, the corresponding time duration of constant voltage charging is shortened, thereby reducing the total charging time of the power supply, and increasing the charging speed.

In the power supply charging method provided by the present disclosure, when the power supply is in the charging state, the power supply management chip directly detects the positive electrode voltage of the cell inside the power supply, and controls the charging mode of the power supply based on the detected positive electrode voltage. Compared with the method for detecting the positive electrode voltage of the power supply to control the charging mode of the power supply, directly detecting the positive electrode voltage of the cell is of higher accuracy. As a result, the timing at which the charging mode of the power supply is controlled to be switched from the constant current mode into the constant voltage mode is of higher accuracy, thereby lengthening the constant current charging time, reducing the total charging time of the power supply, and increasing the charging speed.

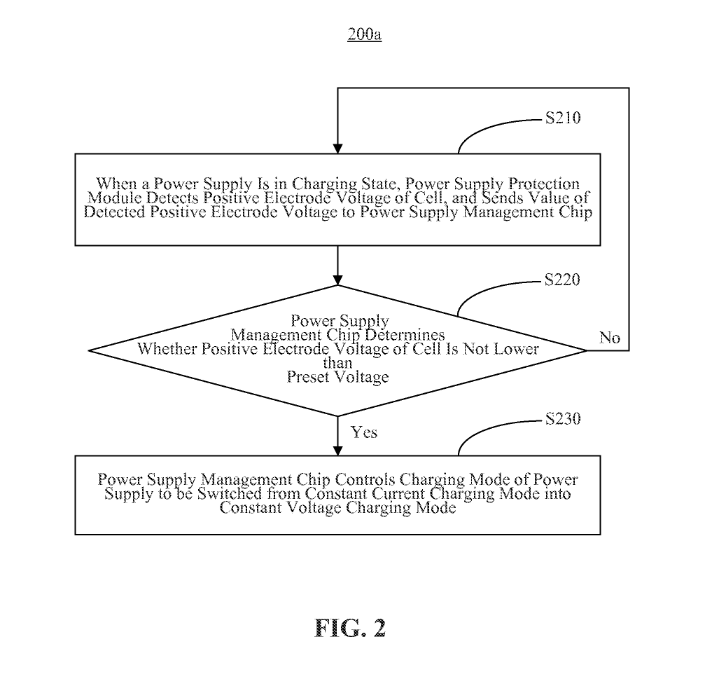

FIG. 2 is a flowchart of a power supply control method 200a, according to an exemplary embodiment, in which the positive electrode voltage of the cell is detected by a power supply protection module. For example, the method 200a may be applied in a power supply charging circuit, and the power supply includes the cell and the power supply protection module. Referring to FIG. 2, the method 200a includes the following steps.

In step S210, when the power supply is in the charging state, the power supply protection module detects the positive electrode voltage of the cell, and sends a value of the detected positive electrode voltage to the power supply management chip.

In one exemplary embodiment, the power supply protection module may send the detected positive electrode voltage of the cell to the power supply management chip via a set pin of the power supply. The set pin may be a new pin, such as a fourth pin added on the power supply that is configured to have an electrical connection function and a communication connection function.

In another exemplary embodiment, the power supply protection module may send the detected positive electrode voltage of the cell to the power supply management chip via an id pin of the power supply. The power supply management chip may also acquire a power supply id number that represents an identity of the power supply via the id pin of the power supply. The id pin of the power supply is a multiplex pin, and is configured to have an electrical connection function and a communication connection function. Such a mode does not require a new pin on the power supply, thereby reducing production costs of the power supply.

In step S220, the power supply management chip determines whether the positive electrode voltage of the cell is not lower than a preset voltage. If it is determined that the positive electrode voltage of the cell is not lower than the preset voltage, step S230 is performed. If the positive electrode voltage of the cell is lower than the preset voltage, the method 200a returns to step S210.

In step S230, the charging mode of the power supply is controlled to be switched from a constant current charging mode into a constant voltage charging mode.

In the power supply charging method 200a, the power supply protection module in the power supply detects the positive electrode voltage of the cell, and sends the detected positive electrode voltage of the cell to the power supply management chip. The power supply management chip controls the charging mode of the power supply based on the received positive electrode voltage of the cell. Compared with the method for detecting the positive electrode voltage of the power supply to control the charging mode of the power supply, directly detecting the positive electrode voltage of the cell is of higher accuracy. As a result, the timing at which the charging mode of the power supply is controlled to be switched from the constant current mode into the constant voltage mode is higher accuracy, thereby lengthening the constant current charging time, reducing the entire charging time of the power supply, and increasing the charging speed.

In one exemplary embodiment, the power supply protection module may be further configured to detect a state of a protection element in the cell. When an abnormal situation occurs to the power supply, the power supply protection module protects the cell by controlling the protection element to be turned off. The method may also include the following steps.

1) The power supply protection module detects a current passing through the protection element connected in series between the negative electrode of the cell and the power supply management chip; and

2) when it is detected that the current of the protection element exceeds a preset range, the protection element is cut off. The protection element may include a switch transistor, and the power supply protection module may cut off the protection element by controlling the switch transistor to be turned off, so as to achieve the protection of the cell.

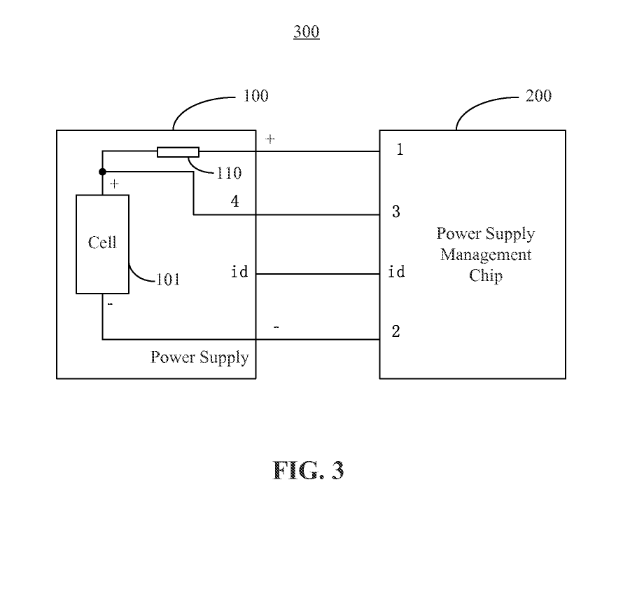

FIG. 3 is a block diagram of a power supply charging circuit 300, according to an exemplary embodiment. Referring to FIG. 3, the power supply charging circuit 300 includes a power supply 100 and a power supply management chip 200. The power supply 100 includes a positive pin, a negative pin, an id pin, and a fourth pin 4. The power supply 100 includes at least a cell 101 and a protection circuit (not shown in FIG. 3) therein. The negative electrode of the cell 101 is electrically connected to the negative electrode of the power supply 100, and in some embodiments, the negative electrode of the power supply 100 is electrically connected to a ground end.

In exemplary embodiments, a protection element 110 is connected between the positive electrode of the cell 101 and the positive electrode of the power supply 100. The protection element 110 may be a thermal resistor having a positive temperature coefficient. When a charging current or a discharging current of the cell is too large, the temperature of the thermal resistor rises, and the impedance value of the thermal resistor increases in a step mode that functions to restrict the current. In doing so, the protection element 110 prevents the cell from being impacted by a large current and functions to protect the cell. After the abnormal condition is removed, the temperature of the thermal resistor is decreased, and the thermal resistor is restored to a low impedance state.

The power supply in the embodiments of the present disclosure may be a battery in a mobile terminal device (such as a mobile phone, a PDA or the like), or may be electricity storage means in other devices, which is not limited by the present disclosure.

In exemplary embodiments, a first pin 1 of the power supply management chip 200 is electrically connected to the positive electrode of the power supply 100, a second pin 2 is electrically connected to the negative electrode of the power supply 100, a third pin 3 is connected to the positive electrode of the cell 101 via the fourth pin 4 of the power supply 100. The fourth pin 4 is configured to have an electrical connection function and a communication connection function. The id pin of the power supply 100 is electrically connected to an id pin of the power supply management chip 200.

The power supply management chip 200 detects the positive electrode voltage of the cell 101 via the fourth pin 4 of the power supply, and controls the charging mode of the power supply 100 based on the detected positive electrode voltage of the cell 101.

When the power supply management chip 200 detects that the positive electrode voltage of the cell 101 is not lower than a preset voltage, the power supply management chip 200 controls the charging mode of the power supply 100 to be switched from the constant current mode into the constant voltage mode.

In the power supply charging circuit 300, the third pin 3 of the power supply management chip 200 is electrically connected to the positive electrode of the cell 101 in the power supply 100 via the fourth pin 4 of the power supply 100. Thus, the power supply management chip 200 detects the positive electrode voltage of the cell 101 and controls the charging mode of the power supply 100 based on the detected positive electrode voltage of the cell 101. By detecting the positive electrode voltage of the cell 101, the timing at which the charging mode of the power supply is controlled to be switched from the constant current mode into the constant voltage mode is of higher accuracy, thereby lengthening the time duration of constant current charging, reducing the total charging time of the power supply, and increasing the charging speed.

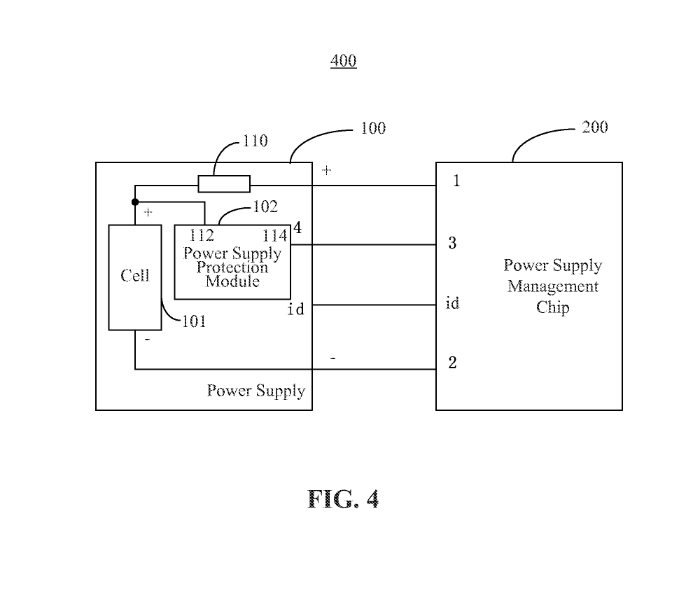

FIG. 4 is a block diagram of a power supply charging circuit 400, according to an exemplary embodiment. In the power supply charging circuit 400, the power supply 100 includes a power supply protection module 102.

Referring to FIG. 4, a detection end 112 of the power supply protection module 102 is electrically connected to the positive electrode of the cell 101. An output end 114 of the power supply protection module 102 is electrically connected to the power supply management chip 200 via the fourth pin 4. In some embodiments, the fourth pin 4 is configured to have a communication connection function. The power supply protection module 102 detects the positive electrode voltage of the cell 101 via the detection end 112 and sends the detected positive electrode voltage of the cell 101 to the power supply management chip 200 via the fourth pin 4. As used in the present disclosure, an end of a module or device can be any input/output terminal of the module or device.

The power supply management chip 200 determines whether the received positive electrode voltage of the cell 101 is not lower than a preset voltage. If the positive electrode voltage of the cell 101 is not lower than the preset voltage, the power supply management chip 200 controls the charging mode of the power supply 100 to be switched from a constant current charging mode into a constant voltage charging mode, thereby lengthening the time duration of constant current charging, reducing the entire charging time of the power supply, and increasing the charging speed.

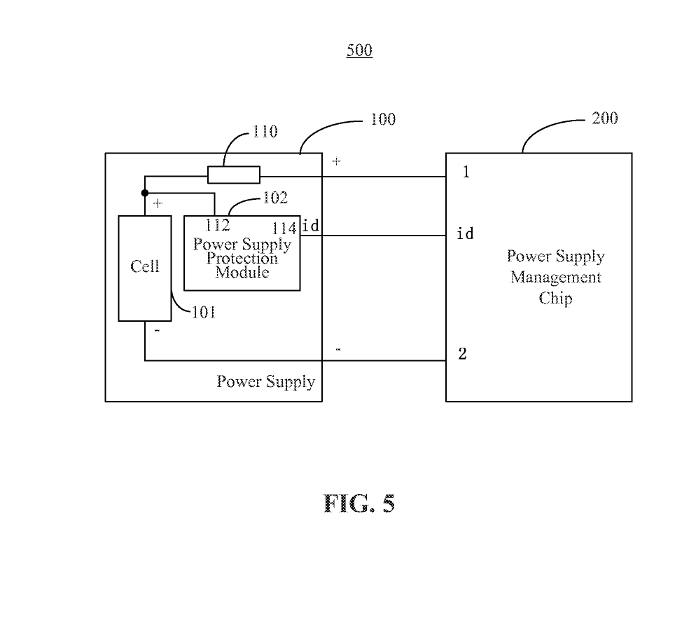

FIG. 5 is a block diagram of a power supply charging circuit 500, according to an exemplary embodiment, which differs from the embodiment shown in FIG. 4 in that, the power supply protection module 102 sends the detected positive electrode voltage of the cell 101 to the power supply management chip 200 via the id pin of the power supply 100. The id pin of the power supply 100 is a multiplex pin for an electrical connection and a communication connection. This embodiment does not require adding a new pin on the power supply 100, thereby reducing production costs of the power supply charging circuit.

The detection end of the power supply protection module 102 is electrically connected to the positive electrode of the cell 101. The output end 114 is electrically connected to the id pin of the power supply 100, and sends the detected positive electrode voltage of the cell 101 to the power supply management chip 200 via the id pin of the power supply 100. The power supply management chip 200 determines whether the positive electrode voltage of the cell 101 is not lower than the preset voltage. If the positive electrode voltage of the cell 101 is not lower than the preset voltage, the power supply management chip 200 controls the charging mode of the power supply 100 to be switched from the constant current mode into the constant voltage mode, thereby lengthening the time duration of a constant current charging mode, shortening the entire charging time of the power supply, and increasing the charging speed of the power supply.

In the power supply charging circuit 500, the positive electrode voltage of the cell detected by the power supply protection module 102 is sent to the power supply management chip 200 using the existing id pin of the power supply 100 in a multiplex mode. As it is not required to add a new pin on the power supply 100, production costs of the power supply charging circuit is reduced.

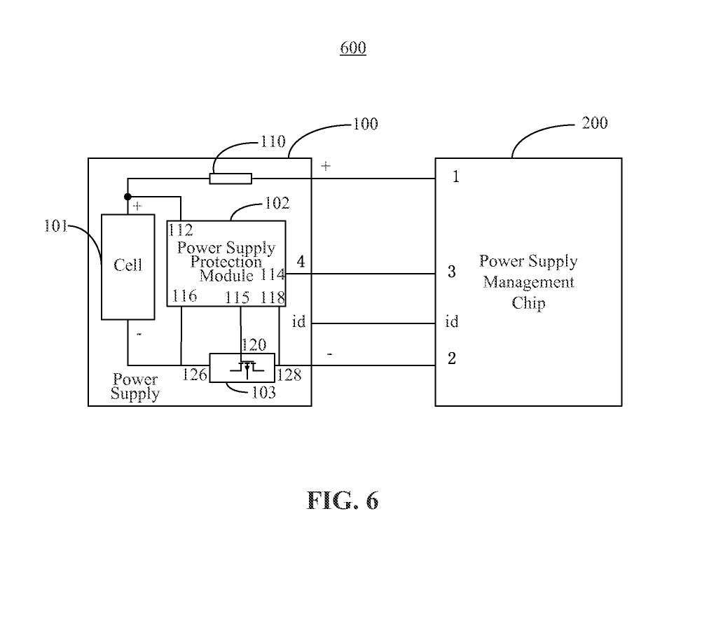

FIG. 6 is a block diagram of a power supply charging circuit 600, according to an exemplary embodiment. In this embodiment, the negative electrode of the cell 101 within the power supply is connected with a protection element 103, and the power supply protection module 102 is configured to cut off the protection element 103 to protect the cell 101 from being damaged when an abnormal situation occurs to the power supply 100. The power supply protection module 102 may detect a state of the protection element 103 in the power supply 100, in addition to detecting the positive electrode voltage of the cell 101 and sending the detected positive electrode voltage of the cell 101 to the power supply management chip 200.

As shown in FIG. 6, the protection element 103 is connected in series to the negative electrode of the cell 101. The protection element 103 includes, e.g., a switch transistor. The power supply protection module 102 includes the detection end 112 as a first detection end, a second detection end 116, a third detection end 118, the output end 114 as a first output end, and a second output end 115.

The second detection end 116 of the power supply protection module 102 is electrically connected to a first end 126 of the protection element 103, and the third detection end 118 of the power supply protection module 102 is electrically connected to a second end 128 of the protection element 103. The second output end 115 is electrically connected to a control end 120 of the switch transistor. The power supply protection module 102 is configured to detect a current passing through the protection element 103. When the current exceeds a preset range, a control signal for turning off the switch transistor is output through the second output end 115. In doing so, when a charging current or a discharging current of the power supply 100 is too large, the protection element 103 is cut off to prevent the cell 101 from being impacted by a large current, so as to guaranty the safety of the cell and lengthen service life of the cell.

The switch transistor may be selected from a MOS transistor (Metal Oxide Semiconductor), where the control end of the switch transistor is a gate electrode of the MOS transistor. The switch transistor may also adopt other types of transistors.

In the power supply charging circuit 600, the functionality of detecting the positive electrode voltage of the cell is implemented by the existing power supply protection module and does not require implementation of additional function modules in the power supply. Therefore, the power supply charging circuit 600 provides the advantage of reducing the occupying area of the circuit layout within the power supply, thereby reduces the volume of the power supply charging circuit, and reduces the volume of a terminal device that uses this power supply charging circuit.

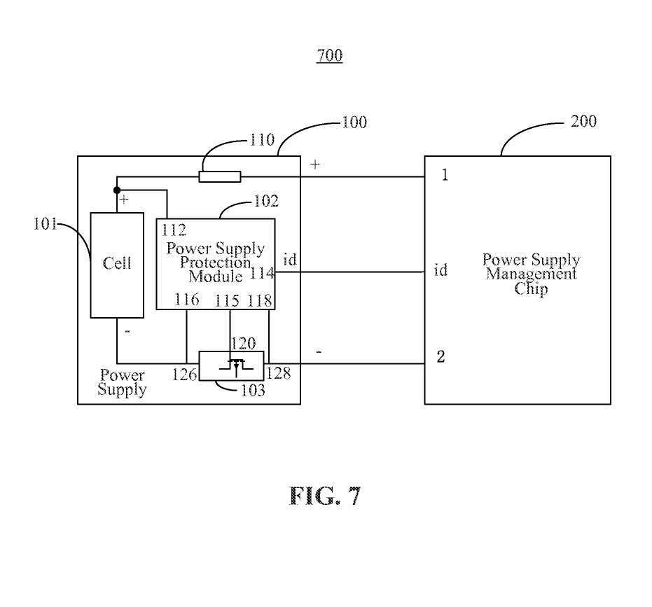

FIG. 7 is a block diagram of a power supply charging circuit 700, according to an exemplary embodiment, which differs from the embodiment shown in FIG. 6 in that, the first output end 114 of the power supply protection module 102 is electrically connected to the id pin of the power supply 100, wherein the id pin is used as a multiplex pin for an electrical connection and a communication connection. The power supply protection module 102 may detect the state of the protection element 103 in the power supply 100 and detect the positive electrode voltage of the cell 101 at the same time, and send the detected positive electrode of the cell 101 to the power supply management chip 200 via the id pin.

The power supply protection module 102 in the power supply 100 is implemented with similar functionalities described above in connection with FIG. 6. The power supply charging circuit 700 further uses the id pin of the power supply 100 in a multiplex mode, such that the id pin is configured to have an electrical connection function and a communication connection function, removing the need to add a new pin on the power supply. In doing so, production costs of the power supply are reduced which in turn reduces production costs of the power supply charging circuit.

Corresponding to the above embodiments of the power supply charging circuit, the present disclosure further provides embodiments of the power supply, respectively.

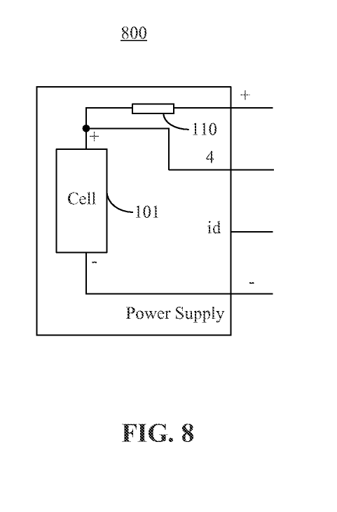

FIG. 8 is a block diagram of a power supply 800, according to an exemplary embodiment, which is of the same structure as the power supply in the power supply charging circuit in FIG. 3. The power supply 800 may be a battery in a mobile terminal device (such as a mobile phone, a pad or the like), or may be electricity storage means in other devices, which is not limited by the present disclosure.

In exemplary embodiments, pins of the power supply 800 include the positive pin, the negative pin, the id pin, and the fourth pin 4. The power supply 800 includes the cell 101 and the protection circuit (not shown in FIG. 8) therein. The positive electrode of the cell 101 is electrically connected to the fourth pin of the power supply, and sends the positive electrode voltage of the cell 101 to the power supply management chip via the fourth chip 4.

The positive electrode of the cell 101 is connected in series to an end of the protection element 110, and another end of the protection element 110 is used as the positive pin of the power supply. The protection element 110 may be a thermal resistor having a positive temperature coefficient. When a charging current or a discharging current of the cell is too large, the temperature of the thermal resistor rises, the impedance value of the thermal resistor increases in a step mode that functions to restrict the current, thereby prevents the cell from being impacted by a large current and functions to protect the cell. After the abnormal condition is removed, the temperature of the thermal resistor is decreased, and the thermal resistor is restored to a low impedance state.

In the power supply 800, the positive electrode of the cell 101 is electrically connected to the fourth pin 4 of the power supply 800. In this embodiment, the power supply management chip detects the positive electrode voltage of the cell via the fourth pin of the power supply, and controls the charging mode of the power supply based on the detected positive electrode voltage of the cell.

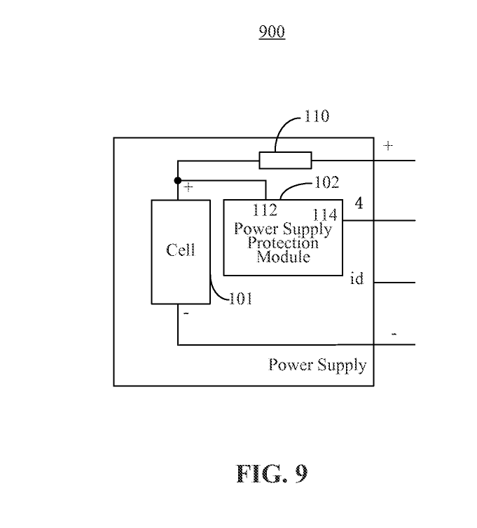

FIG. 9 is a block diagram showing another power supply 900, according to an exemplary embodiment, which is of the same structure as the power supply in the power supply charging circuit shown in FIG. 4.

As shown in FIG. 9, the power supply 900 includes the power supply protection module 102. The detection end 112 of the power supply protection module 102 is electrically connected to the positive electrode of the cell, and the output end 114 of the power supply protection module 102 is electrically connected to the power supply management chip 200 via the fourth pin 4 of the power supply 900. The fourth pin 4 is configured to have a communication connection function. The power supply protection module 102 detects the positive electrode voltage of the cell 101 via the detection end 112 and sends the detected positive electrode voltage of the cell 101 to the power supply management chip 200 via the fourth pin 4.

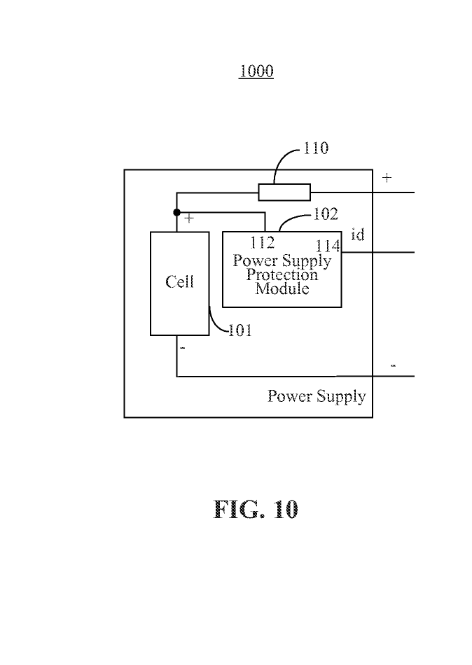

FIG. 10 is a block diagram of a power supply 1000, according to an exemplary embodiment, which is of the same structure as the power supply in the power supply charging circuit shown in FIG. 5. In the power supply 1000, the output end 112 of the power supply protection module 102 is electrically connected to the id pin of the power supply 100, and the power supply protection module 102 sends the detected positive electrode voltage of the cell 101 to the power supply management chip via the id pin of the power supply, wherein the id pin of the power supply is used as a multiplex pin for an electrical connection and a communication connection. The power supply 1000 does not require adding a new pin on the power supply, thereby reducing production costs of the power supply.

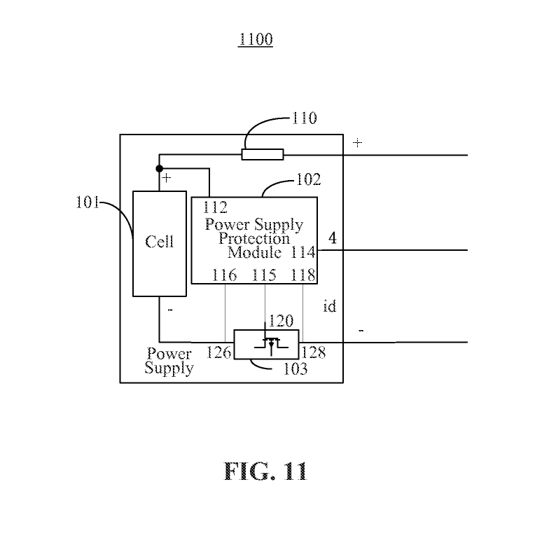

FIG. 11 is a block diagram of a power supply 1100, according to an exemplary embodiment, which is of the same structure as the power supply in the power supply charging circuit shown in FIG. 6. In the power supply 1100, the power supply protection module 102 may detect the state of the protection element 103 within the power supply, in addition to detecting the positive electrode voltage of the cell, and sending the detected positive electrode voltage of the cell to the power supply management chip.

As shown in FIG. 11, the first protection element 103 is connected in series to the negative electrode of the cell 101. The protection element 103 includes, e.g., a switch transistor. The power supply protection module 102 includes the first detection end 112, the second detection end 116, the third detection end 118, the first output end 114, and the second output end 115.

The second detection end 116 of the power supply protection module 102 is electrically connected to the first end 126 of the first protection element 103, and the third detection end 118 is electrically connected to the second end 128 of the first protection element 103. The second output end 115 is electrically connected to the control end 120 of the switch transistor. The power supply protection module 102 is further configured to detect a current passing through the first protection element 103. When the current exceeds a preset range, a control signal for turning off the switch transistor is output through the second output end. In doing so, when a charging current or a discharging current of the power supply is too large, the first protection element 103 is cut off to prevent the cell 101 from being impacted by a large current, so as to guaranty the safety of the cell and lengthen service life of the cell.

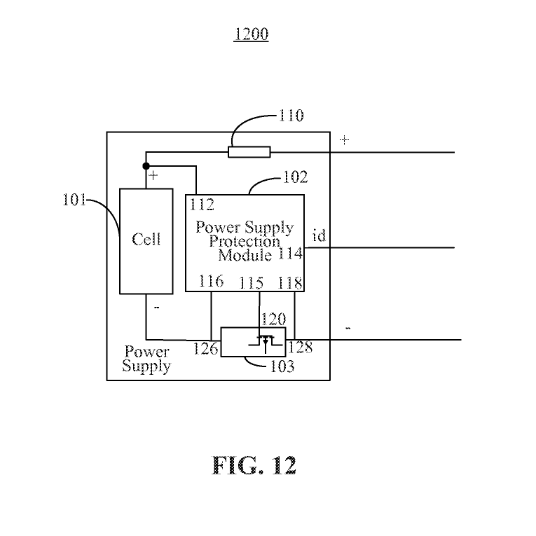

FIG. 12 is a block diagram of a power supply 1200, according to an exemplary embodiment, which is of the same structure as the power supply in the power supply charging circuit shown in FIG. 7. The power supply 1200 differs from the power supply 1100 shown in FIG. 11 in that, the first output end 114 of the power supply protection module 102 is electrically connected to the id pin of the power supply 1200, wherein the id pin of the power supply 1200 is used as a multiplex pin for an electrical connection and a communication connection. The power supply 1200 does not require adding a new pin on the power supply, thereby reducing production costs of the power supply.

In exemplary embodiments, the present disclosure further provides a terminal device, including: a processor, any power supply charging circuit provided by the above embodiments, and other modules, for example, an RF (Radio Frequency) circuit, a storage for a readable storage medium, an input unit, a display unit, a sensor, an audio circuit and a WiFi module or the like.

The power supply in the power supply charging circuit provides a working voltage for various modules in the terminal device, and the processor is used to control processes of the power supply management chip in the power supply charging circuit and other modules in the terminal device.

One of ordinary skill in the art will understand that the above described embodiments may each be implemented by hardware, or software, a combination of hardware and software.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A power supply charging method, comprising:
detecting a positive electrode voltage of a cell in a power supply when the power supply is in a charging state;
determining that the detected positive electrode voltage of the cell is not lower than a preset voltage; and
controlling a charging mode of the power supply to be switched from a constant current charging mode into a constant voltage charging mode.

2. The method according to claim 1, wherein:
the detecting is performed by a power supply management chip,
the power supply management chip is electrically connected to a positive electrode and a negative electrode of the cell, and
when the power supply is in the charging state, the power supply management chip detects a voltage across the positive electrode and the negative electrode of the cell.

3. The method according to claim 2, wherein the power supply management chip is electrically connected to the positive electrode of the cell via a set pin of the power supply.

4. The method according to claim 3, wherein the set pin is an id pin or a fourth pin of the power supply.

5. The method according to claim 4, wherein the fourth pin is configured to have an electrical connection function and a communication connection function.

6. The method according to claim 1, wherein:
a power supply protection module in the power supply detects the positive electrode voltage of the cell when the power supply is in the charging state, and
the power supply protection module sends a value of the detected positive electrode voltage to a power supply management chip.

7. The method according to claim 6, wherein the power supply protection module sends a value of the detected positive electrode voltage of the cell to the power supply management chip via a set pin of the power supply.

8. The method according to claim 6, further comprising:
detecting a current passing through a protection element connected in series between the negative electrode of the cell and the power supply management chip; and
cutting off the protection element when the detected current of the protect element exceeds a preset range.

9. The method according to claim 8, wherein the detecting of the current is performed by the power supply protection module.

10. A power supply charging circuit, comprising: a power supply; and a power supply management chip, wherein:
the power supply comprises a cell,
the power supply management chip is electrically connected to a positive electrode and a negative electrode of the cell in the power supply to detect a positive electrode voltage of the cell, and
the power supply management chip controls a charging mode of the power supply based on the detected positive electrode voltage of the cell.

11. The power supply charging circuit according to claim 10, wherein the power supply further comprises a power supply protection module, and
a first detection end of the power supply protection module is connected to the positive electrode of the cell, and a first output end of the power supply protection module is connected to the power supply management chip via a set pin of the power supply.

12. The power supply charging circuit according to claim 11, wherein the set pin of the power supply is one of an id pin or a fourth pin of the power supply, and the fourth pin is configured to provide an electrical connection function and a communication connection function.

13. The power supply charging circuit according to claim 11, wherein:
a protection element is connected in series between the negative electrode of the cell and a negative electrode of the power supply,
the protection element comprises a switch transistor,
a second detection end of the power supply protection module is electrically connected to a first end of the protection element, a third detection end is electrically connected to a second end of the protection element, and a second output end is electrically connected to a control end of the switch transistor,
the power supply protection module is configured to detect a current passing through the protection element, and
when the detected current exceeds a preset range, a control signal for turning off the switch transistor is output through the second output end.

14. The power supply charging circuit according to claim 10, wherein the power supply management chip is connected to the positive electrode of the cell via a set pin of the power supply.

15. A power supply, comprising: a positive pin; a negative pin; a set pin; a cell; a first protection element; and a second protection element, wherein:
a positive electrode of the cell is connected to the positive pin of the power supply via the second protection element, and is connected to a power supply management chip via the set pin of the power supply, and
a negative electrode of the cell is connected to the negative pin of the power supply via the first protection element.

16. The power supply according to claim 15, further comprising: a power supply protection module, wherein a first detection end of the power supply protection module is connected to the positive electrode of the cell, and a first output end of the power supply protection module is connected to the set pin of the power supply.

17. The power supply according to claim 16, wherein the first protection element comprises a switch transistor, and wherein
a second detection end of the power supply protection module is connected to a first end of the first protection element,
a third detection end of the power supply protection module is connected to a second end of the first protection element,
a second output end of the power supply protection module is connected to a control end of the switch transistor, and
the second output end of the power supply protection module is configured to control a conducting state or a turn-off state of the switch transistor based on a detected current passing through the first protection element.

18. The power supply according to claim 15, wherein the set pin of the power supply is one of an id pin or a fourth pin of the power supply.

19. The power supply according to claim 18, wherein the fourth pin is configured to provide an electrical connection function and a communication connection function.

20. A terminal device, comprising: a processor; and the power supply charging circuit according to claim 10, wherein:
the power supply in the power supply charging circuit provides a working voltage for the terminal device, and
the processor is configured to control the power supply management chip in the power supply charging circuit.
